(19) United States
(12) Patent Application Publication
(10) Pub. No.: US 2019/0063111 A1
(43) Pub. Date: Feb. 28, 2019

(54) MECHANICAL SYSTEM FOR BLOCKING AND OPENING IN A LOCK THAT CAN BE ACTUATED VIA A KEY WITH A LINEAR MOVEMENT, WITHOUT ROTATION

(71) Applicant: PC SECURITY HOMESYSTEMS S.L., Rafal (Alicante) (ES)

(72) Inventor: Camilo Jose LARA FERNANDEZ, (US)

(21) Appl. No.: 15/767,293

(22) PCT Filed: Sep. 26, 2016
(86) PCT No.: PCT/ES2016/070672

§ 371 Date: Jun. 8, 2018

(30) Foreign Application Priority Data
Oct. 10, 2015 (ES) P 201531462

(51) Int. Cl. E05B 29/00; E05B 19/00; E05B 15/10; E05B 63/20; E05B 13/00; E05B 15/04

(52) U.S. Cl. CPC E05B 29/0006; E05B 19/0052; E05B 15/101; E05B 2015/0448; E05B 13/002; E05B 15/04; E05B 63/20

(57) ABSTRACT

The invention relates to a mechanical system for blocking and opening in a lock that can be actuated via a key with a linear movement, without rotation, which does not therefore require a rotation of the key to actuate the opening mechanism, not including any kind of cylinder system. Same comprises two complete parts, as shown in FIG. 1, a special key (1) and the system comprising the set of parts forming the lock. Upon introducing the key with a simple linear movement, and without needing to rotate same, the different mechanical actions are triggered that permit the unblocking of the lock, such that the individual notches of the key press on readers (2), which are to be calibrated, and, only if the position is correct, the mechanisms permitting the opening are released. Same is particularly applicable in embedded locks for all door configurations.

### OBJECT OF THE INVENTION

The present invention refers to a mechanical closing and opening system with a blocking feature in a lock actuated by means of a special flat key without requiring the key to be rotated, with just a linear movement of the key being enough, which does not comprise cylinders, disc tumbler or pin tumbler. This system can be specially applied to any type of locks for all door configurations, turning it into a lock being tamper-proof against the usual tampering methods, since these are unsuccessful and ineffective for tampering and opening the lock, providing it, therefore, with a very high security level.

This system can be used similarly for any type of locks, such as access garage doors, blind closures, latches and padlocks, etc., that is, everything implying the use of a safety lock.

### BACKGROUND OF THE INVENTION

Currently, all the different types of locks and locking or blocking systems use tumbler or cylinder or tumbler pin shapes and models, which make them really vulnerable against the current tampering and vandalism methods and means, implying a low level of real security. One such lock can be seen in the document EP 0751273 A 1 30 (MOTTURA SERRATURE DI SICUREZZA), which shows a blocking and opening system for a lock which is of the tumbler or tumbler pin type.

The problem of these type of blocking and opening systems of a lock is that they are widely known and do not offer security against the tampering methods and/or techniques being currently used. This type of systems and locks are far too different from the one disclosed in the present document, as the disclosure of the present patent application uses a novel system of mechanical readers-feelers which can be actuated by means of a key for opening thereof, wherein serrated keys as those traditionally used are not employed, but a flat key instead having several marks or notches at the end thereof which are recognized by inner readers-feelers, usually being an amount of four readers-feelers, and which allows unblocking and actuating the lock opening. It is therefore not necessary to rotate the key in order to unblock the lock, as existing commercial locks do.

Currently, mechanical locks comprising cylinders, tumblers or tumbler pins (with serrated or dimple keys), including among these those from safety and armoured doors, have ceased to offer the intended security as a consequence of the existence of tampering methods and techniques, involving an evident risk of suffering undesired access, violence, robberies or thefts.

On the other hand, there are those systems using new technologies, such as electric or electronic systems, electromechanical locks or electronic locks that incorporate an electronic identification readers-feeler, with a hidden lock system, systems not using tumblers or cylinders, or use electric tumblers. There is an electronic lock disclosed in the document ES 2408689 T3, showing an electronic lock with an actuating disc.

The problem of this type of lock is that it is vulnerable against other tampering or vandalism systems, such as frequency detectors, or the use of electric or electronic decoding systems, among others, which eventually, by using new technologies, allow the system to be tampered, thus attaining, in a simple manner, unlawful opening of the lock.

The main advantage of the disclosed system as compared to the existing ones is that it is totally mechanical, and therefore invulnerable when using new technologies, electric, electronic and frequency systems, or applying programmes or software or other techniques. And on the other hand the technique being used is totally different to the existing traditional lock systems, which provides it with a unique security level, rendering it invulnerable and tamper-proof against the currently existing methods.

### DESCRIPTION OF THE INVENTION

In order to reach the objectives and avoid the inconvenience described above, especially those related to security, the invention discloses a lock blocking and opening system being totally mechanical, which avoids any act of vandalism or tampering using the methods and techniques currently known, rendering it immune thereto, mainly for the absence of systems where a key has to be rotated, since said traditional systems are substituted by a set of readers-feelers, usually in a number of four, that upon actuation thereof with a special key, they allow operating the mechanism that causes the lock unblocking and opening.

This invention for locks uses a novel mechanism wherein neither a cylinder nor rotating the key are necessary in order to unblock the latches, with a simple linear movement of the key being enough.

The mechanism comprises notch gauges that read the notches in the key, which in turn move pieces allowing the opening movements to bypass security by unblocking the opening and locking bolts.

Unblocking occurs when the gauges are perfectly aligned, since only this way the washers will be concentric with the plunger, or the geometric figure used, and this will slide and move the trigger for the other components to act unblocking the system used for blocking the opening.

The main characteristic of these locks is the way they act since it is only necessary to introduce the key and push it deep inside, thus rendering the key rotation unnecessary and only by slightly pushing the door this will be open.

### DESCRIPTION OF THE DRAWINGS

To implement the present description being made and in order to provide a better understanding of the characteristics of the invention, according to a preferred practical embodiment thereof, a set of drawings is attached as part of this description, with an illustrative but not limitative purpose, which represents the following:

FIG. 1.—It shows a view of the outer side of the device of the invention.

FIG. 2.—It shows a view of the inner side of the device of the invention.

FIG. 3.—It shows a front view of the device of the invention.

FIG. 4.—It shows an enlargement of the rear view of the device of the invention.

FIG. 5.—It shows a detail of the special opening key.

FIG. 6.—It shows a detail of the readers-feelers.

FIG. 7.—It shows a detail of the retaining plate.

FIG. 8.—It shows a detail of the bolt washer.

FIG. 9.—It shows a detail of the bolt.

FIG. 10.—It shows a detail of the bolt shaft.

FIG. 11.—It shows a detail of the piece working as a pawl.

FIG. 12.—It shows a detail of the opening flange.

FIG. 13.—it shows a detail of the flange guide.

FIG. 14.—It shows a detail of the knob leg.

FIG. 15.—It shows a detail of the head of the knob shaft.

FIG. 16.—It shows a detail of the body of the opening handle.

FIG. 17.—It shows a detail of the inner opening disarming unit.

FIG. 18.—It shows a detail of the rocker element for blocking the opening from inside.

FIG. 19.—It shows a detail of the disarming button.

FIG. 20.—It shows a detail of the tongue.

FIG. 21.—It shows a detail of opening leg.

FIG. 22.—It shows a detail of the tongue guide.

FIG. 23.—It shows a detail of the body of the key mechanisms.

FIG. 24.—It shows a detail of the safety catch of the locking channel.

FIG. 25.—It shows a detail of the locking channel.

FIG. 26.—It shows a detail of the lock support.

FIG. 27.—It shows a detail of the pushing cone.

FIG. 28.—It shows a detail of the flat safety element.

FIG. 29.—It shows a detail of the limiter.

FIG. 30.—It shows a detail of the arming unit.

FIG. 31.—It shows a detail of the guiding support of the arming unit.

FIG. 32.—It shows a detail of the shield.

FIG. 33.—it shows a detail of the distance gauge.

FIG. 34.—It shows a detail of the pushing shaft of the gauge.

FIG. 35.—It shows a detail of the protective shutter.

FIG. 36.—It shows a detail of the retaining plate bridging piece.

FIG. 37.—it shows a detail of the shield closure.

FIG. 38.—It shows a detail of the knob guide.

FIG. 39.—It shows a detail of the knob.

FIG. 40.—It shows a detail of the knob button.

FIG. 41.—It shows detail of the shaft of the leg of the knob.

FIG. 42.—It shows a detail of the opening disarming shaft.

FIG. 43.—It shows a perspective detail of the key actuation on the readers-feelers arranged onto the body of the key mechanism.

FIGS. 44 and 45.—They show details of the retaining plate before and after being coupled onto the readers-feelers.

FIG. 46.—It shows a detail being similar to that of FIG. 45, but which represents the blocking washer of the bolt.

FIGS. 47 and 48.—They show perspective and exploded views of the assembly of the previous figure from different perspectives, assembly to which the retaining/releasing mechanism of the corresponding bolt.

FIG. 49.—It shows a similar view to that of FIG. 1, but with the device in a deployment situation for the tongue (16).

FIG. 50.—It shows an opposing view of the assembly of the previous figure.

FIG. 51.—It shows a perspective view of the lock partially disassembled, in order to see more clearly the mechanism of the locking tunnel and safety catch of the locking tunnel that stops the locking tongue.

FIG. 52.—It shows a similar view to that of FIG. 51, but representing the piece associated to the pushing cone in a phase in which it comes closer to the mechanism blocking the tongue.

FIG. 53.—It shows a similar view to that of the previous figure, but in which the arming unit is completely inserted into the lock, and consequently, the pushing cone associated thereto releases the tongue by means of axial displacement of the safety catch of the locking tunnel with respect to the locking tunnel.

FIG. 54.—It shows a view of the profile of the assembly of the previous figure, at a time when, since the tongue is released, this is displaced up to the blocking position thereof.

FIG. 55.—It shows a perspective view, being opposite to that of the previous figures, related to the retracting mechanism of the pushing cone so that it does not interfere in the tongue retraction and thus provides for the door opening.

### PREFERRED EMBODIMENT OF THE INVENTION

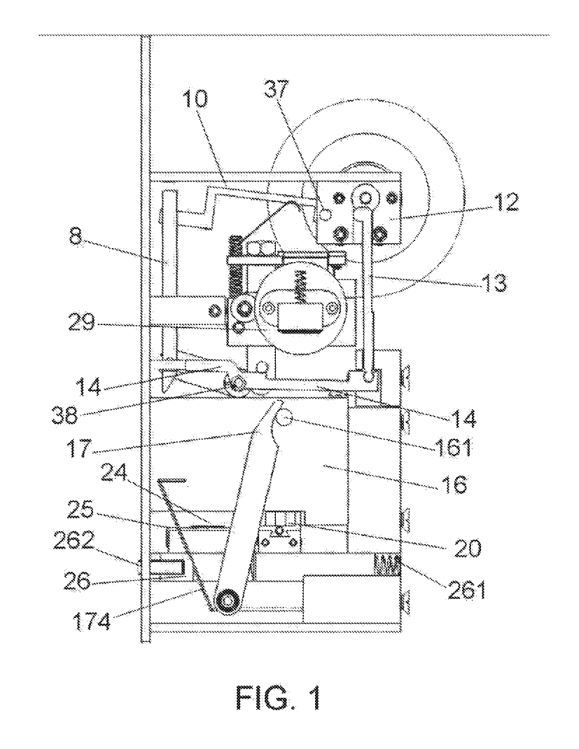

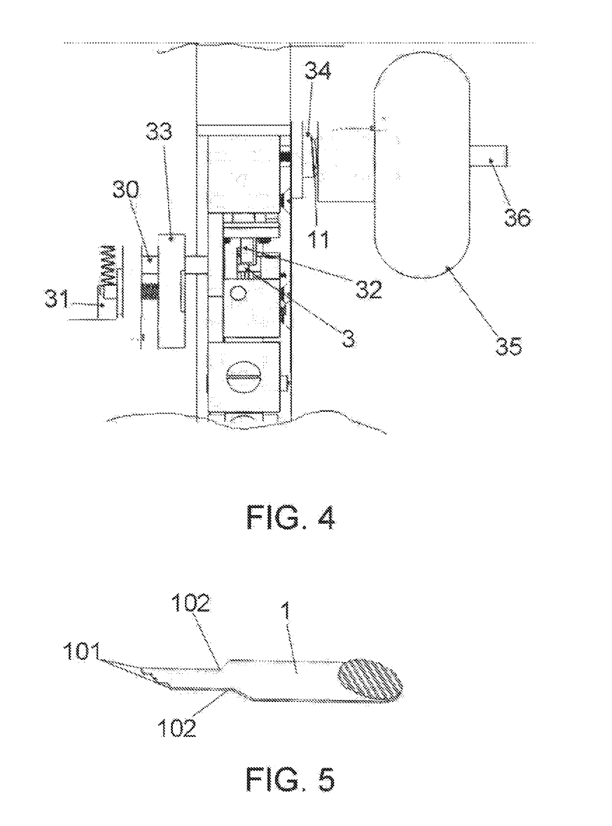

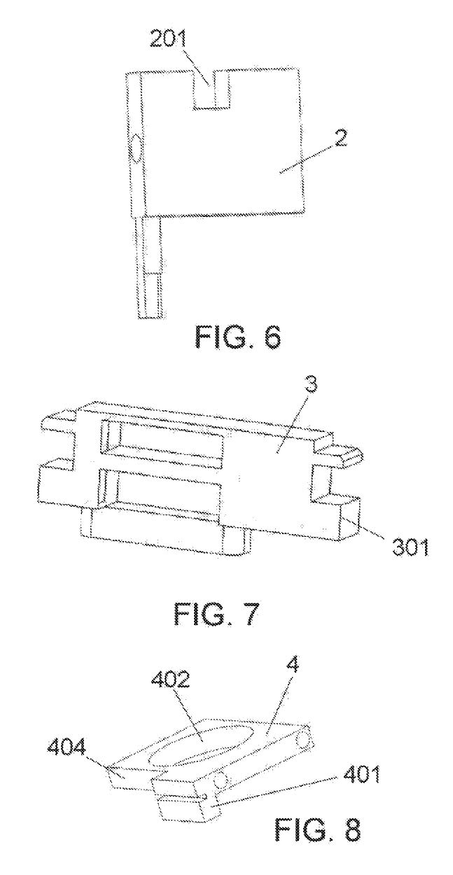

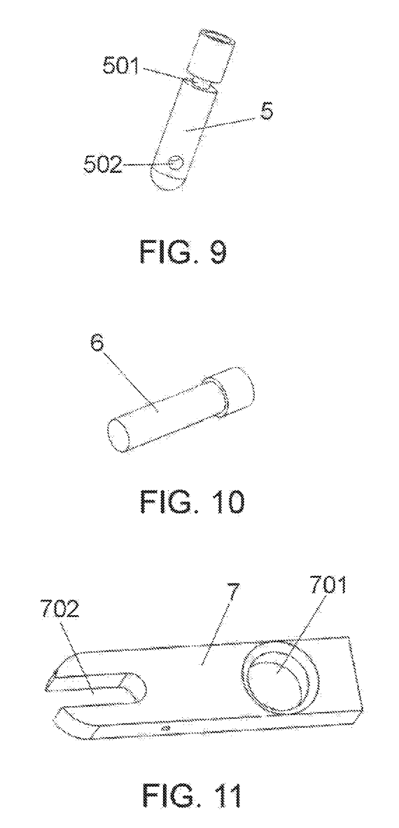

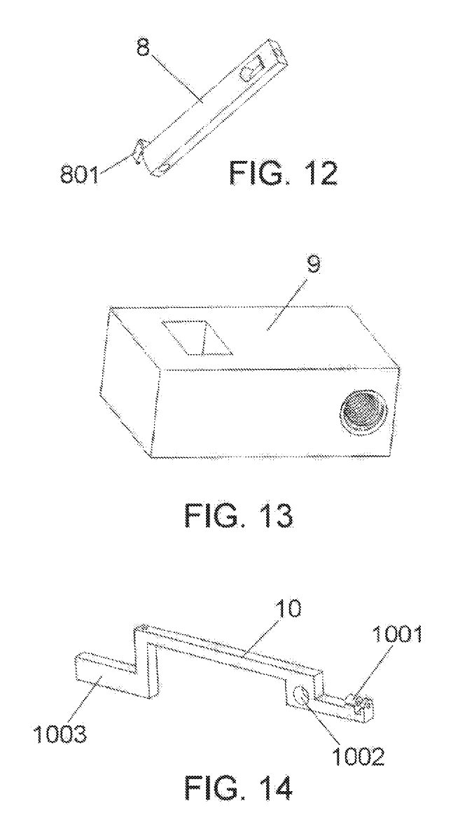

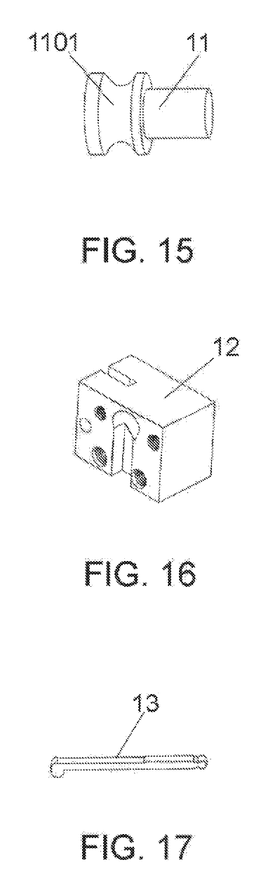

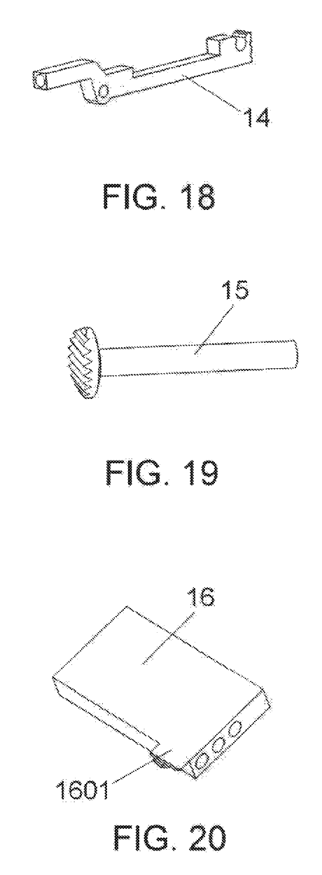

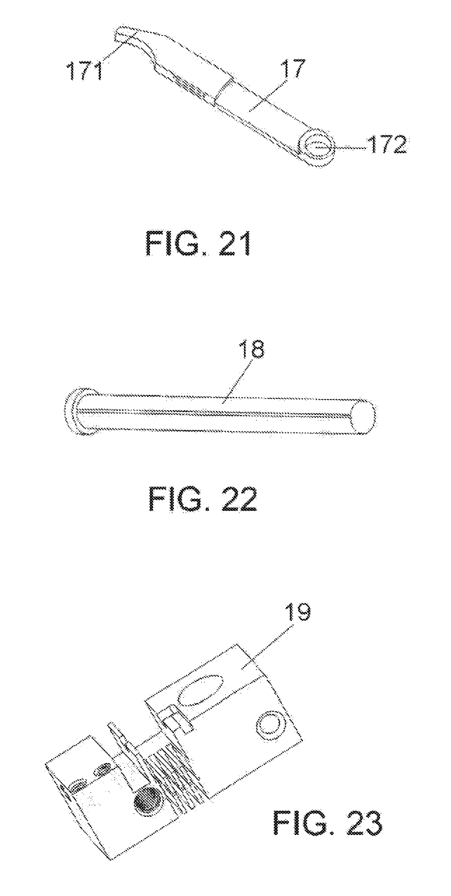

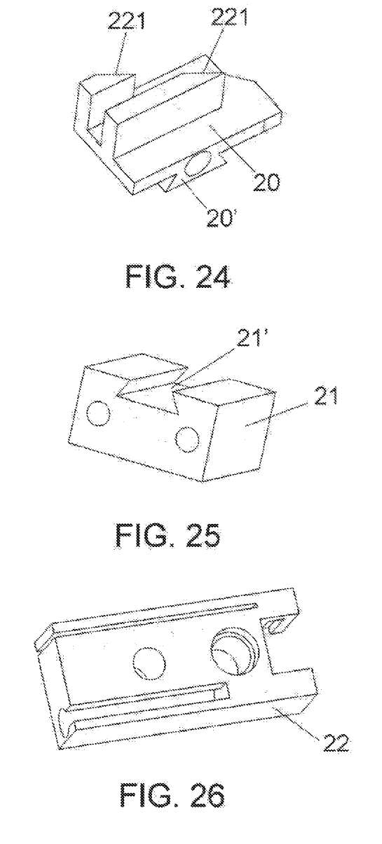

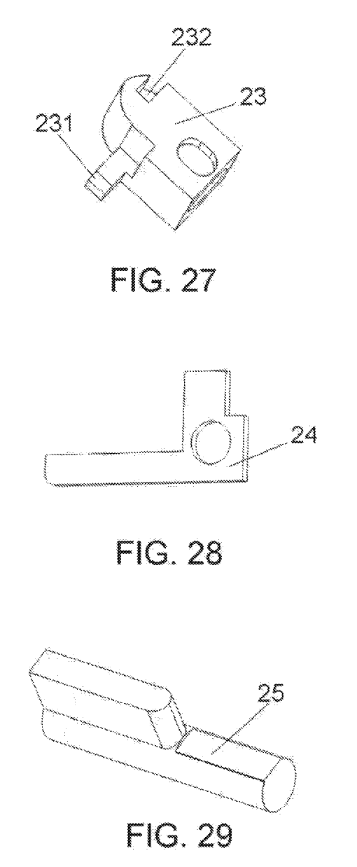

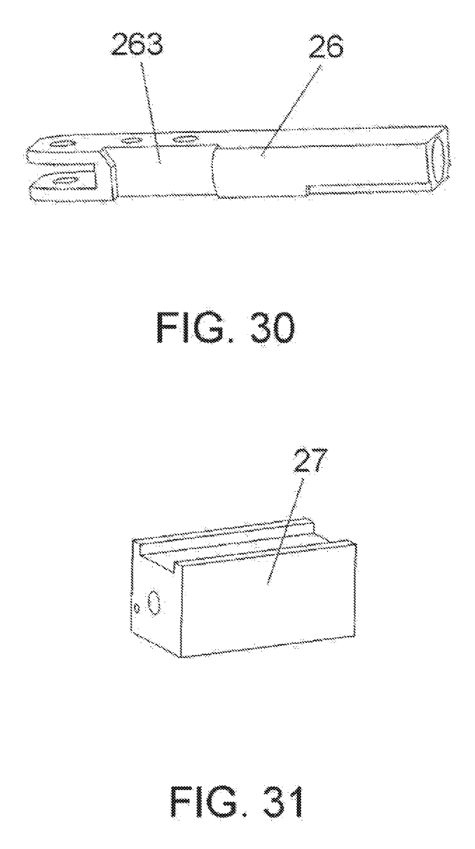

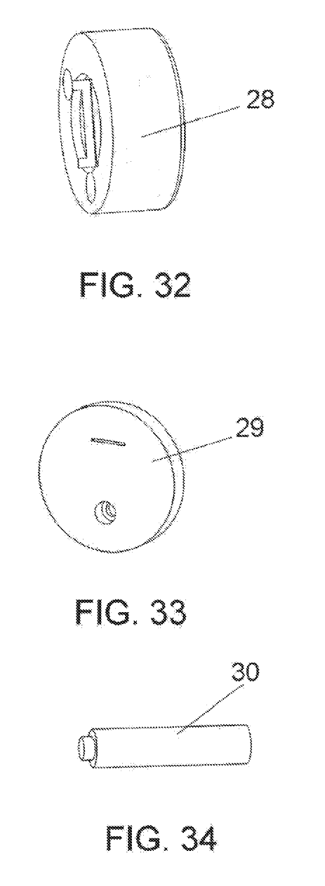

As it has been indicated, and as it can be appreciated in FIGS. 1 to 4, the mechanical blocking and opening system in a lock without tumblers or cylinders, actuated by means of a special key featuring linear movement, object of the invention, in the preferred embodiment thereof, comprises two global parts, as it is shown in FIG. 1, a special key (1) and the system comprising the set of pieces making up the lock, said pieces being made of steel although other materials can be used having similar characteristics. As indicated above, operation of the pieces, as the preferred embodiment is as follows:

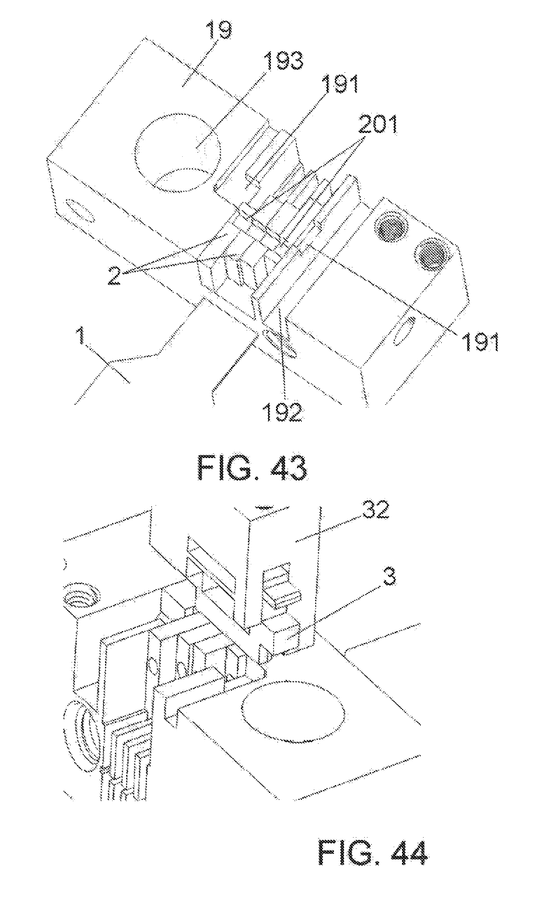

The key (1), is introduced horizontally through the slot, also horizontal, which is in the shield (28), until reaching the bottom, in such a way that the unique notches (101) of the key push the readers-feelers (2), as it can be observed in FIG. 43, usually a number of four.

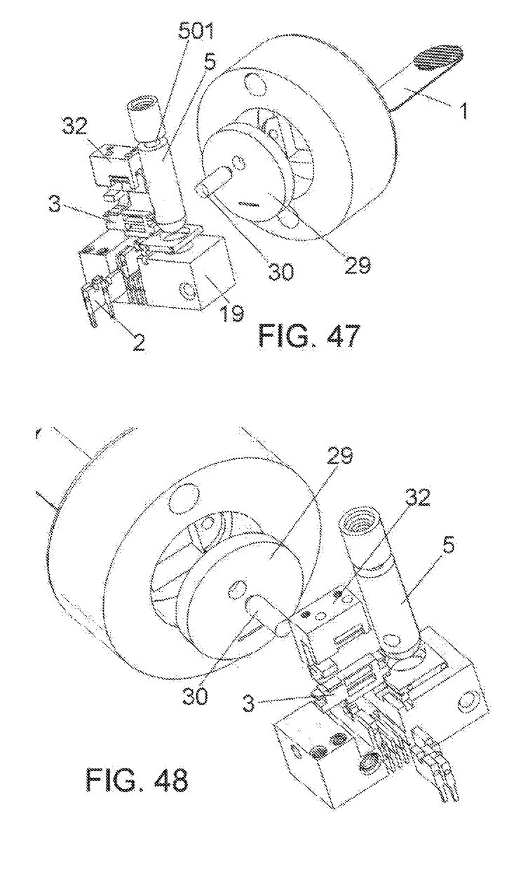

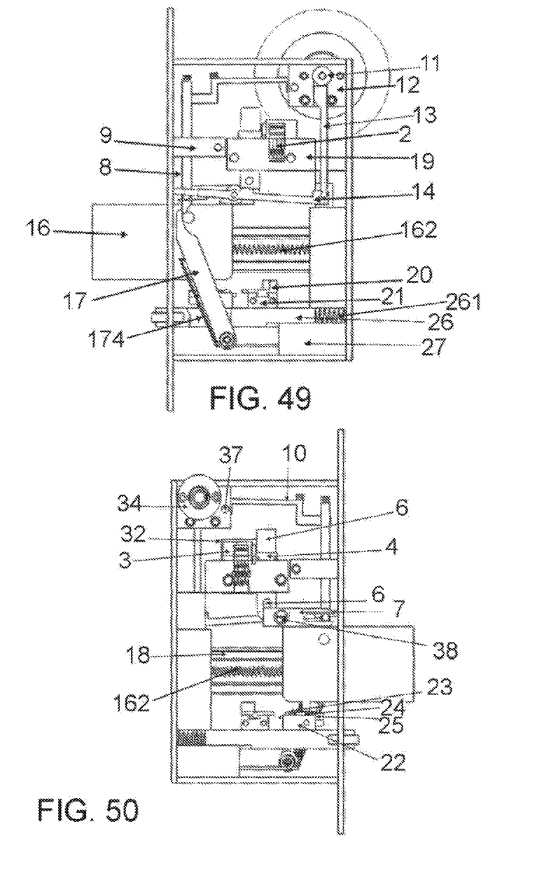

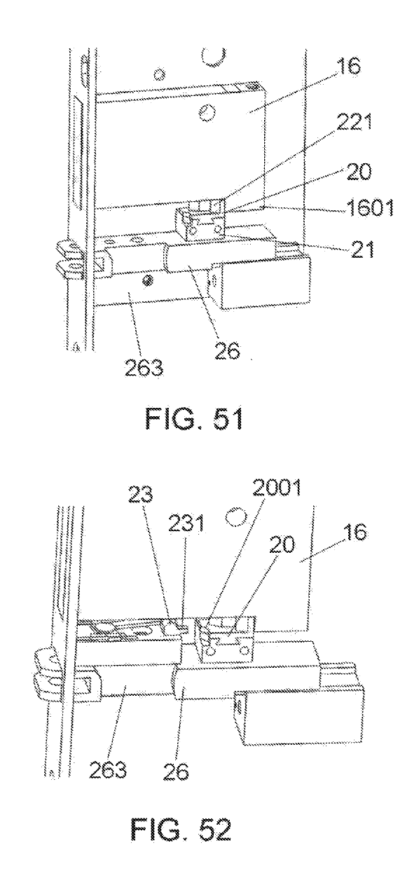

Before that, the inclined sides (102) of the key (1) abut against the distance gauge (29) which is arranged just before the body of the key mechanism (19) (see FIGS. 47 and 48), in such a way that the distance gauge (29) abuts against the pushing shaft (30) of the gauge, which in turn will keep on pushing the bridging piece of the retaining plate (32), where the retaining plate accommodation (3) is found, moving at the same time as one, from that moment onwards, a distance of 4 millimetres, in such a way that if the key is the correct one, this will cause an alignment of the notches (201), of the different readers-feelers (2), as it is shown in FIG. 43, said notches that, once being aligned, will displace those 4 millimetres until being similarly aligned to a pair of notches (191) established in the body of the key mechanism (19).

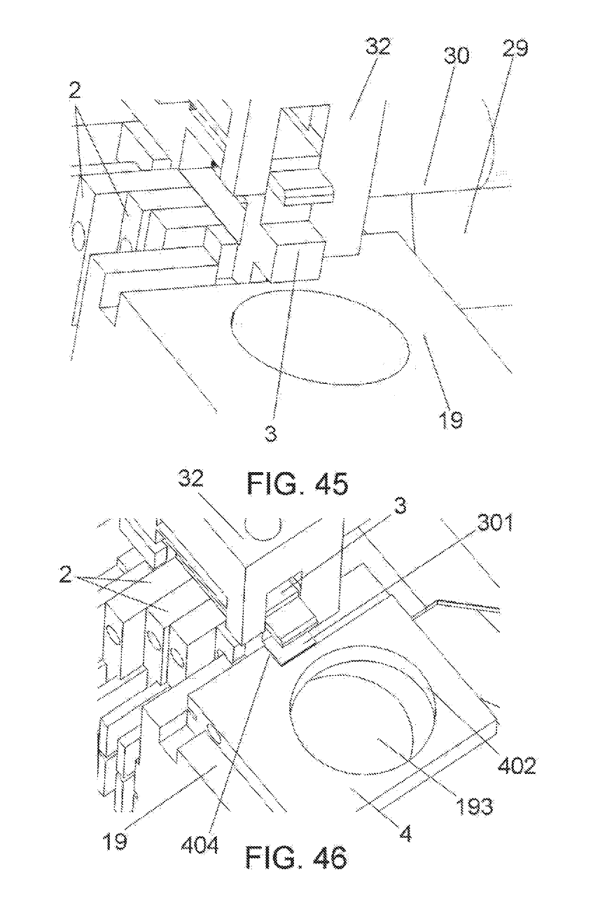

The channel being defined once the notches (201) are aligned with the notches (191) is dimensioned so as to vertically couple with the retaining plate (3) in said channel, as it is shown in FIGS. 44 and 45, said retaining plate (3) being vertically displaced inside the bridging piece (32) of the retaining plate.

Said retaining plate (3) finishes at one of the ends thereof in a flange (301), such that in the body of the key mechanisms (19) a guiding groove (192) is defined wherein the piece referred to as washer (4) is displaced by means of a projection (401) that runs into said guiding groove (192), having an orifice (402) of a diameter corresponding to that of the bolt (5) and being biased with respect to an orifice (193) established in the body of the key mechanisms (19), of the same diameter, in such a way that the washer (4) tends to be biased by the action of a spring blocking the bolt (5) that is inserted between these two orifices.

For a safe blocking of said bolt (5), this comprises a perimetral groove (501), into which the washer (4) couples when this is biased from the orifice (193) of the body of the mechanism (19).

Thereby, and as it can be observed in FIG. 46, once the retaining plate comes down and is coupled onto the notches (201) and (191) the flange (301) thereof is aligned to a projection (404) of the washer (4) such that the displacement of the key, and consequently of the whole assembly, causes the orifices (402) of the washer (4) and (193) of the body of the key mechanisms (19) to be aligned, thus releasing the bolt (5).

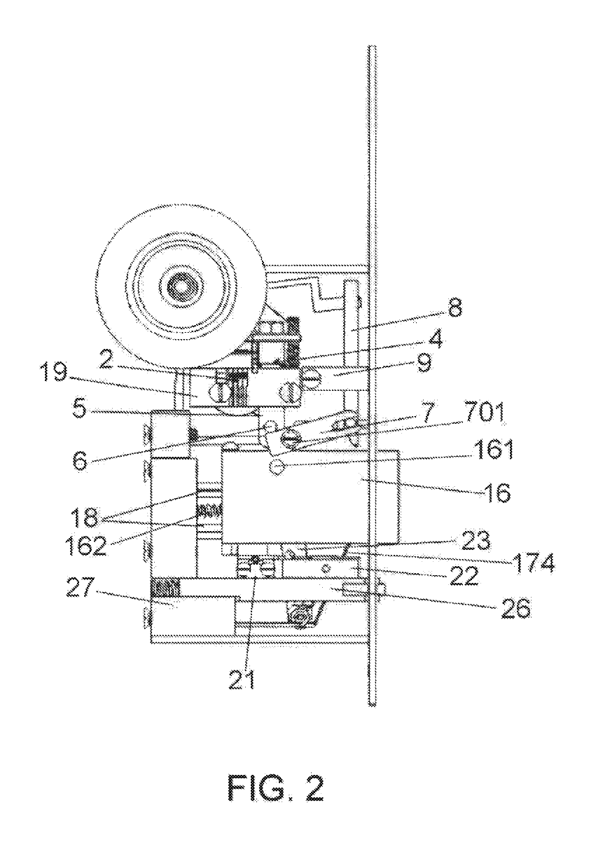

At this point, the bolt (5) will fall, this being provided with an axial and radial orifice (502) into which the shaft of the bolt (6) is inserted, pressing onto the pawl (7), as it is shown in FIG. 2.

This piece, the pawl (7), acts as a rocker element by means of a rotating shaft (701), and lifts the opening flange (8) related to said pawl (7) through an end (702) thereof, said flange running vertically in a guide of the flange (9), said flange (8) releasing in turn the piece referred to as opening leg (17).

More particularly, in the opening leg (17) there is defined a rear inclined end (171) and a rotating shaft (173), said element being associated to a spring (174), such that before releasing the bolt (5), the opening leg (17) is retained by the end (801) of the opening flange (8).

Upon releasing the opening leg (17), this draws the tongue (16) backwards, by means of a lug (161) onto which the end (171) of the opening leg (17) pushes against the tension of a spring associated to said tongue (16).

On the other hand, the tongue (16) has three orifices in its rear side, two orifices being cylindrical, where the tongue guides (18) slide with a linear movement, keeping it always in the same path, whereas the third orifice has a spring coupled thereto which is in charge of pushing said tongue at the locking moment.

Said tongue (16) comprises an extension (1601) having ribs susceptible of facing ribs (221) which are defined in the safety catch of the locking tunnel (20), displacing transversely with respect to the tongue (16) displacement through a locking tunnel (21) by means of a tongue and groove (20′-21′) system, said locking tunnel (21) being integral to the lock frame or casing.

Thus, based on the biased condition or not of the safety catch of the locking tunnel (20) with respect to the ribs being defined in the extension (1601) of the tongue, this could block or slide between the channels being defined between said ribs.

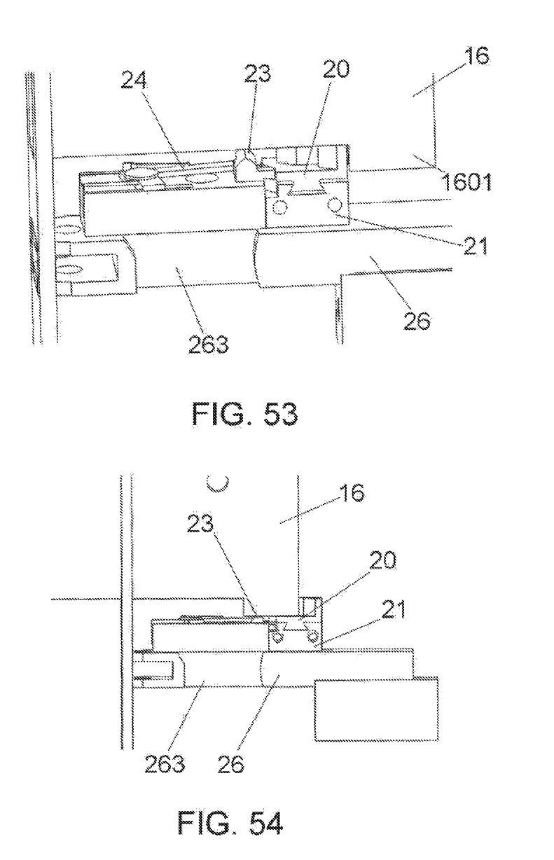

In order to control this biasing of the safety catch of the locking tunnel (24), and according to FIG. 52, a pushing cone (23) has been provided being associated to the arming unit (26) displacement, wherein an arm (231) is defined which, as it can be observed in FIG. 53, in the displacement thereof being integral to the arming unit (26), it contacts the chamfer edge (2001) of the locking safety catch (20), such that this inclined arrangement causes transversal displacement of the mentioned locking safety catch (20), biasing the ribs thereof with respect to that of the tongue (16), which causes this to be released, such as it is shown in FIG. 54.

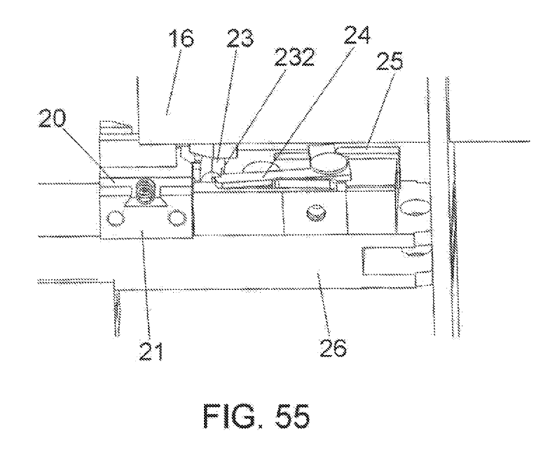

According to FIG. 55, previously, and before reaching the locked position, the tongue (16) passes above the pushing cone (23) and pushes it downwards until the flat safety catch (24) is introduced in the channel (232) that the pushing cone (23) has for this purpose, thus remaining engaged and allowing the tongue (16) to be fixed by the safety catch of the locking tunnel (24) when retracting.

This last movement is not possible if the pushing cone (23) is not engaged at the bottom, since at the top, in its usual place, at the moment of closing the door, it is the one releasing the tongue (16) upon pushing the safety catch of the locking tunnel (24). Consequently, the pushing cone (23), defines the element that allows unblocking the opening.

The opening cycle from outside with the key is thus finished.

In this situation being described, the tongue (16) is in the stand-by position thereof, with the door being unblocked, it has passed between the channels of the safety catch of the locking tunnel (20), since the channels having inclined sides (221) if this piece and those of the tongue extension will have pushed the springs of the safety catch of the locking tunnel (20), but after said piece passing through these channels, the safety catch of the locking tunnel (20) returns to its position and prevents the tongue (16) to come out again. The transversal flat sides of both pieces remain opposite facing each other, thus preventing the tongue (16) to leave the stand-by position.

In said situation, two forces converge on the tongue (16), one spring (174) causes it to retract and another (162) pushes it outwards.

Upon opening the door, the piece referred to as arming unit (26) is released, wherein said piece had been up to that moment (with the door closed), resting onto the door frame forcing it to remain hidden. This arming unit (26) is provided with a grooving (263) into which the opening leg (17) is intended to run, relating the mechanism associated thereto to the position in which the arming unit is arranged.

Thus, when opening the door, the arming unit (26) is pushed outwards by a well-regulated spring (261), and the following operations are realized:
1. Taking the knob leg (10) up to the stand-by position thereof, by displacing the opening leg (17), thus cancelling the spring (174) retracting force, with this piece remaining engaged to the piece referred to as opening flange (8), by means of an end (801) thereof until the opening is actuated.
2. Taking the piece referred to as limiter (25), (see FIG. 55), being integral to said arming unit (26), until abutting with the plate forming the front of the lock and thus pushing the piece referred to as flat safety catch (24), makes this to come out of its channel (232) and releases the pushing cone (23) upward movement, so that at the moment of closing the door, the projection of this piece pushes the chamfer edge (2001) of the safety catch of the locking tunnel (20), and displaces this until releasing the passage of the tongue extension and the stand-by position is reached.

The arming unit (26), at the front side thereof, has a bearing (262) being coupled for providing for the friction originated with the frame when locking the door. This bearing helps returning the arming unit (26) up to the locking position thereof.

In order to open the door from inside, it is only necessary to press the knob button (36), with the following pieces being involved: knob button (36), by pressing it the head of the knob is (11) is pushed, this finishing in an end having a perimetral “U”-shaped groove (1101), resting onto the end (1001) of the knob leg (10), which is articulated over a tilting shaft (1002), as a rocker, such that axial displacement of the head of the knob shaft (11), particularly its “U”-shaped groove, causes a slight angular displacement for the knob leg (10), which due to the proximity of the tilting shaft (1002), that small displacement is magnified at the opposite end (1003) thereof, said end causing the opening flange (8) to be lifted, releasing, in turn, the opening leg (17) and the opening movement is thus finished.

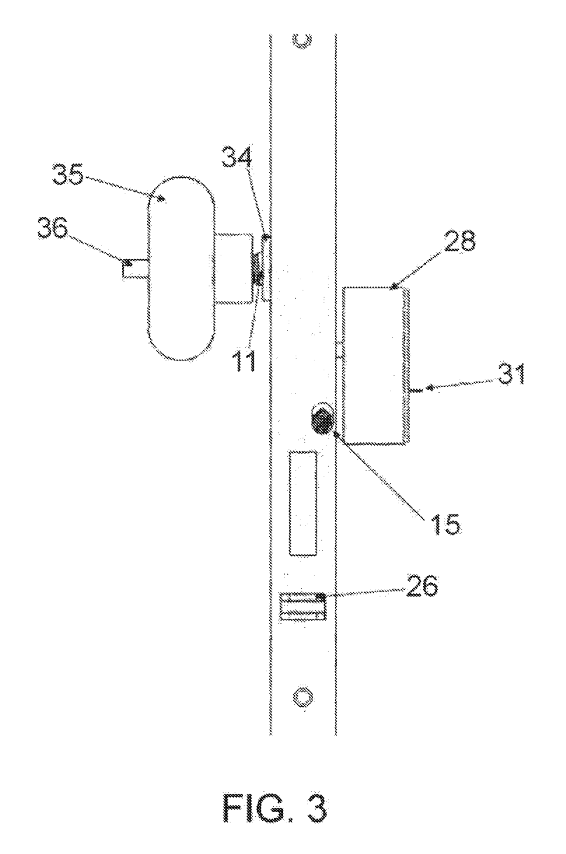

Likewise, it can be prevented from being open from inside by actuating the piece referred to as disarming button (15), which is at the front side of the lock (FIG. 3), over the tongue (16) cavity. This piece allows that, by lowering it down, the outlet is blocked from inside. The disarming button (15) is fitted into the opening blocking rocker (14) from inside, transmitting the movement of the inner opening disarming unit (13) and this blocks the movement of the head of the knob shaft (11), so the knob button (36) will remain immoveable. On the other hand, the knob (35) acts as a guide for the piece referred to as knob button (36).

These mechanisms are inside a box formed by plates, a front one, another rear, upper and lower one and the side, outer and rear cover, which close the system making up the lock.

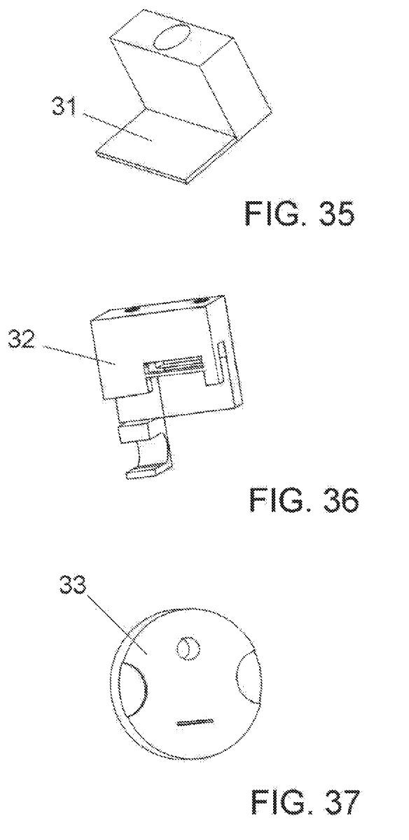

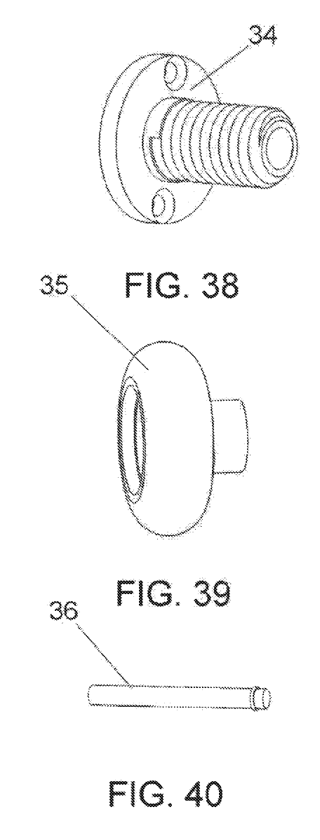

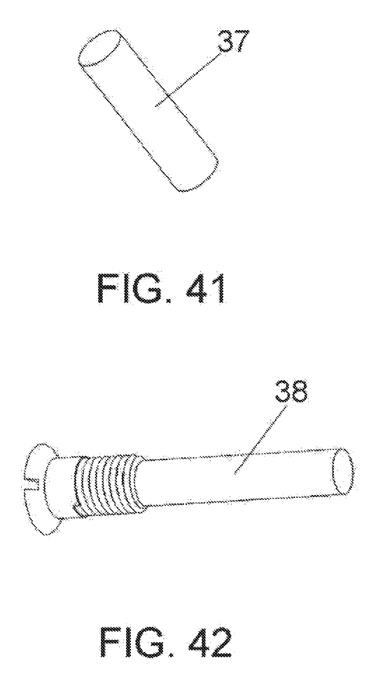

FIG. 35, shows a piece that works as a protective shutter (31), which is closed over the inlet slot and in the key direction so as to actuate the mechanism, thus protecting it from external agents and protecting the inlet channel of the key against vandalism.

As it can be observed from the description and detail of the preferred embodiment of the invention, it is easily liable to industrial application, said industrial application being clearly guessed from the nature of the invention and explanation thereof.

1. Mechanical blocking and opening system in a lock actuated by means of a key with linear movement without rotation, wherein a flat key participates therein, at the end of which a profile having a series of notches is defined, said lock itself being provided with a shield, with the corresponding slot for the key to pass through, being defined, inside the lock, a body of the key mechanism wherein a plurality of readers-feelers can be displaced by the end of said key being pressed against them, readers-feelers that have at the upper part thereof a series of notches that are aligned upon displacing through the correct profile of the key, said displacement being regulated by means of a distance gauge which is arranged just before the body of the key mechanism, in such a way that the distance gauge abuts the pushing shaft of the gauge, which displaces a bridging piece of a retaining plate being vertically displaced inside said bridging piece, such that in the body of the key mechanisms two notches are defined which are aligned to the notches alignment when inserting the correct key, all this assembly defining an accommodation for the retaining plate to be vertically fitted in, which comprises at the end thereof a flange which during the axial displacement caused by the key insertion displaces a washer, with an orifice that, when being in a stand-by condition, tends to be biased by the action of a spring, with respect to an orifice drilled in the body of the key mechanisms, said orifice through which a bolt is vertically displaced, which during the lower displacement thereof, presses onto a pawl acting as a rocker which in turn lifts an opening flange as a retaining element of an opening leg that tends to retracting the tongue by pulling thereof through a lug by the action of a spring, this tongue being in turn associated to a spring by means of which it is urged towards its extracting position and to the blocking position for the lock.

2. Mechanical blocking and opening system in a lock actuated by means of a key with linear movement without rotation, according to claim 1, wherein in the opening leg there is defined a rear inclined end and a rotating shaft, said element being associated to a spring, in such a way that before releasing the bolt, the opening leg is retained by the end of the opening flange.

3. Mechanical blocking and opening system in a lock actuated by means of a key with linear movement without rotation, according to claim 1, wherein the tongue has two cylinders, the tongue guide keeping it always in the same path.

4. Mechanical blocking and opening system in a lock actuated by means of a key with linear movement without rotation, according to claim 1, wherein the tongue can be displaced over a pushing cone, being blocked by means of a flat safety catch, which is introduced in a channel incorporating said pushing cone, thus being engaged, allowing the tongue to pass over in the opposite direction and be retracted.

5. Mechanical blocking and opening system in a lock actuated by means of a key with linear movement without rotation, according to claim 1, wherein the bolt, comprises a perimetral groove, into which the washer couples when this is biased from the orifice of the body of the mechanism.

6. Mechanical blocking and opening system in a lock actuated by means of a key with linear movement without rotation, according to claim 1, wherein the system further comprises an automatic locking system when closing the door and it is made up of an arming unit, which in a locking condition of the door is resting on the door frame, and upon opening thereof the arming unit is pushed outwards by a spring, being provided with a grooving into which the opening leg is intended to run, in such a way that during its retracting displacement it is susceptible of acting onto a mechanism cancelling the spring retracting force, this piece being engaged to the piece referred to as opening flange, by means of its end until the opening is actuated or a limiter is displaced until abutting with the plate forming the lock front, and thus pushing a flat safety catch, making this to come out of the channel of the pushing cone thus releasing it so that, at the moment of locking the door, a projection or arm of this piece pushes onto a chamfer edge of the safety catch of the locking tunnel, and being transversely displaced and provided with ribs susceptible of blocking, based on the transverse position thereof, lower ribs which are arranged in an extension of the tongue.

7. Mechanical blocking and opening system in a lock actuated by means of a key with linear movement without rotation, according to claim 6, wherein the piece referred to as arming unit, at the front part thereof has a bearing coupled thereto so as to provide for friction originated with the frame when locking the door.

8. Mechanical blocking and opening system in a lock actuated by means of a key with linear movement without rotation, according to claim 1, wherein in order to open the door from inside, the device comprises a knob button, pushing the head of the knob shaft, which finishes at an end having a “U”-shaped perimetral groove, resting on the end of the knob leg, which is articulated to a tilting shaft as a rocker, in such a way that the axial displacement of the head of the knob shaft, transmits the movement to the piece referred to as knob leg which causes the opening flange to open, releasing, in turn, the opening leg with the lock being released.

9. Mechanical blocking and opening system in a lock actuated by means of a key with linear movement without rotation, according to claim 1, wherein the system further comprises a disarming button which is at the front of the lock, over the cavity for the tongue, said disarming button being fitted into the opening blocking rocker from inside, transmitting the movement to the inner opening disarming unit and this blocks the movement of the head of the knob shaft.

10. Mechanical blocking and opening system in a lock actuated by means of a key with linear movement without rotation, according to claim 1, wherein the inlet and direction slot of the key is assisted by a protective shutter mechanism for protection thereof.
